(19) United States
(12) Patent Application Publication
(10) Pub. No.: US 2022/0292985 A1
(43) Pub. Date: Sep. 15, 2022

(54) METHOD FOR OPEARTING A TRANSPORTATION SYSTEM

(71) Applicants: Ningbo Geely Automobile Research & Development Co., Ltd., Ningbo (CN); Zhejiang Geely Holding Group Co., Ltd., Zhejiang (CN)

(72) Inventors: Magnus BRANDIN, Mölnlycke (SE); Markus BÖLANDER, Göteborg (SE); Markus SÖDERLUND, Lerum (SE); Vanessa OLSSON, Göteborg (SE)

(21) Appl. No.: 17/831,756

(22) Filed: Jun. 3, 2022

Related U.S. Application Data
(63) Continuation of application No. PCT/CN2020/134619, filed on Dec. 8, 2020.

(30) Foreign Application Priority Data
Dec. 9, 2019 (EP) 19214511.8

(51) Int. Cl. G08G 1/00; G08G 1/16; B60W 30/14; B60W 30/18; B60W 30/165; B60W 40/04; G05D 1/02

(52) U.S. Cl. CPC G08G 1/22; G08G 1/20; G08G 1/167; B60W 30/143; B60W 30/18163; B60W 30/165; B60W 40/04; G05D 1/0295; G05D 1/0293; B60W 2554/406; B60W 2554/80; G05D 2201/0213

(57) ABSTRACT

A method for operating a transportation system including a first vehicle platoon and a second vehicle platoon, each having a lead vehicle and a plurality of vehicles following the lead vehicle. The method includes the steps of controlling the first vehicle platoon and the second vehicle platoon by means of a control system, driving the first vehicle platoon in a first lane of a road and the second vehicle platoon in a second lane of the road, where the road comprises a bottleneck section where the first lane and the second lane merge into a single lane, and controlling the first vehicle platoon and the second vehicle platoon such that the first vehicle platoon and the second vehicle platoon are synchronized before reaching the bottleneck section enabling the first vehicle platoon and the second vehicle platoon to enter the single lane one after the other.

### RELATED APPLICATION DATA

This application is a continuation of International Patent Application No. PCT/CN2020/134619, filed Dec. 8, 2020, which claims the benefit of European Patent Application No. 19214511.8, filed Dec. 9, 2019, the disclosures of which are incorporated herein by reference in their entireties.

### TECHNICAL FIELD

The invention relates to a method for operating a transportation system and a control system for controlling vehicles of a transportation system.

### BACKGROUND

Today's transportation or traffic systems for transporting passengers have a relatively low capacity and public transport timetables often cannot be kept without delays. One way of trying to increase the capacity of the total traffic flow is to organize the vehicles in vehicle platoons, where each vehicle platoon has a lead vehicle and a plurality of following vehicles driving in a convoy after the lead vehicle.

There is however still a need for optimizing the use of such vehicle platoons and enabling vehicle platoons to pass bottlenecks of a road network in an effective way for providing a relatively high throughput of vehicle platoons.

### SUMMARY

An objective of the invention is to provide a method for operating a transportation system, by which method the throughput of vehicle platoons through a road network bottleneck can be increased.

The objective is achieved by a method for operating a transportation system comprising a first vehicle platoon and a second vehicle platoon, where each of the first and second vehicle platoons has a lead vehicle and a plurality of vehicles following the lead vehicle, and the method comprises the steps of controlling the first vehicle platoon and the second vehicle platoon by means of a control system, driving the first vehicle platoon in a first lane of a road and the second vehicle platoon in a second lane of the road, the road comprising a bottleneck section where the first lane and the second lane merge into a single lane, and controlling the first vehicle platoon and the second vehicle platoon such that the first vehicle platoon and the second vehicle platoon are synchronized before reaching the bottleneck section enabling the first vehicle platoon and the second vehicle platoon to enter the single lane one after the other.

The invention is based on the insight that by such a method, it is possible to provide a relatively high flow of vehicle platoons through a road network bottleneck, since by use of the control system for synchronization of the vehicle platoons the time gap between the vehicle platoons can be minimized and the driving can be planned for maintaining a relative high speed and avoiding any stoppage of any vehicle platoon. The time, speed and position of the vehicles platoons can be synchronized by the control system. This will also save energy since any deceleration and acceleration of the vehicle platoons required for passing the bottleneck section, can be minimized.

According to one embodiment of the method, the method comprises the step of positioning the first vehicle platoon in front of the second vehicle platoon before the bottleneck section, enabling the first vehicle platoon to enter the single lane before the second vehicle platoon. Hereby, it is possible to drive the first and second vehicle platoons through the bottleneck section in a safe way.

According to a further embodiment of the method, the method comprises the step of positioning the first vehicle platoon in front of the second vehicle platoon by increasing the speed of the first vehicle platoon relative to the speed of the second vehicle platoon before the bottleneck section by increasing the speed of the first vehicle platoon and/or decreasing the speed of the second vehicle platoon. Hereby, the first vehicle platoon can be positioned in front of the second vehicle platoon immediately before the bottleneck section.

According to a further embodiment of the method, the method comprises the step of controlling the first vehicle platoon to change from the first lane to the second lane of the road, and driving the first vehicle platoon in front of the second vehicle platoon in the second lane when reaching the bottleneck section. Hereby, it can be ensured that the first vehicle platoon will enter the single lane before the second vehicle platoon in a safe way.

According to a further embodiment of the method, the method comprises the step of controlling the second vehicle platoon to change from the second lane to the first lane of the road, and driving the second vehicle platoon behind the first vehicle platoon in the first lane when reaching the bottleneck section. Hereby, it can be ensured that the first vehicle platoon will enter the single lane before the second vehicle platoon in a safe way.

According to a further embodiment of the method, the method comprises the step of controlling the relative speed between the first vehicle platoon and the second vehicle platoon, and the positions of the first vehicle platoon and the second vehicle platoon relative to each other, based on the length of the first vehicle platoon, before reaching the bottleneck section. Hereby, the throughput can be optimized at the same time as safety can be ensured.

According to a further aspect of the invention, a further objective of the invention is to provide a control system for controlling vehicles of a transportation system, by which control system the throughput of vehicle platoons through a road network bottleneck can be increased.

The objective is achieved by a control system for controlling vehicles of a transportation system comprising a first vehicle platoon and a second vehicle platoon, where each of the first and second vehicle platoons has a lead vehicle and a plurality of vehicles following the lead vehicle, and the control system is configured to control the first vehicle platoon driving in a first lane of a road and the second vehicle platoon driving in a second lane of the road, wherein the road comprises a bottleneck section where the first lane and the second lane merge into a single lane, and the control system is configured to control the first vehicle platoon and the second vehicle platoon such that the first vehicle platoon and the second vehicle platoon are synchronized before reaching the bottleneck section enabling the first vehicle platoon and the second vehicle platoon to enter the single lane one after the other.

In addition, the invention relates to a transportation system comprising a first vehicle platoon and a second vehicle platoon, and such a control system.

The advantages of the control system and the transportation system are similar to the advantages already discussed hereinabove with reference to some embodiments of the method.

Further advantages and advantageous features of the invention are disclosed in the following description and in the claims.

### BRIEF DESCRIPTION OF THE DRAWINGS

With reference to the appended drawings, below follows a more detailed description of embodiments of the invention cited as examples.

In the drawings:

FIG. 1 shows a vehicle platoon, and

FIG. 2 shows a transportation system with vehicle platoons and a control system for controlling the vehicle platoons.

### DETAILED DESCRIPTION

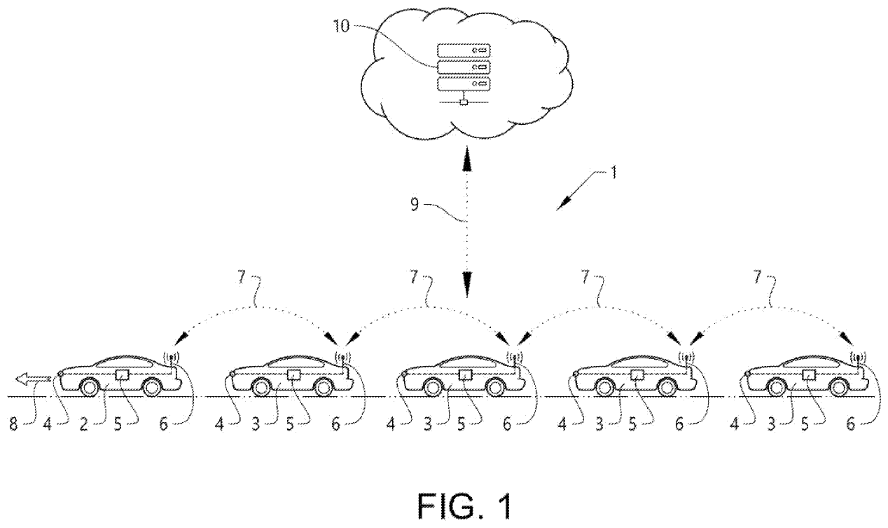

FIG. 1 shows a vehicle platoon 1 having a lead vehicle 2 and a plurality of following vehicles 3. The lead vehicle 2 and the following vehicles 3 are individual vehicles but driven together as a group or convoy. The following vehicles 3 are positioned in a line after the lead vehicle 2. The driving direction is indicated with an arrow 8. The lead vehicle 2 can be a so called autonomous or self-driving vehicle, or the lead vehicle 2 can be at least partly controlled by an operator of the lead vehicle. The following vehicles 3 of the vehicle platoon are suitably automatically controlled without any driver assistance. The vehicle platoon is suitably used for transportation of passengers of the vehicles, though the vehicles can also be used for transporting goods.

When driving in the vehicle platoon 1, the following vehicles 3 are controlled to follow the lead vehicle 2 or the vehicle closest to the front, such that when the speed of the lead vehicle 2 is increased/decreased the speed of the following vehicles 3 is increased/decreased correspondingly for maintaining or achieving the desired distances and time gaps between the vehicles. Further, when the lead vehicle 2 is changing driving direction, a following vehicle 3 will also change driving direction and follow the lead vehicle or rather the vehicle closest to the front.

For enabling the vehicles 2, 3 to be controlled, each vehicle can be provided with any suitable sensor equipment 4 for receiving information about the environment, and a control unit 5 for controlling the vehicle. The sensor equipment gives information about at least the vehicle closest to the front, but preferably the sensor equipment is covering 360 degrees around the vehicle for obtaining the information that is required for longitudinal and lateral control of the vehicle. Such sensor equipment 4 may comprise LIDAR, radar and ultrasonic sensors, cameras, etc. The information received by the sensor equipment is used by the control unit 5 for controlling the driving behaviour of the vehicle. In addition, maps, GPS, etc., can be used for determining the current position of a vehicle platoon or an individual vehicle of a vehicle platoon.

Alternatively or in addition to the sensor equipment 4, each vehicle 2, 3 is provided with a communication unit 6 for communicating with one or more of the other vehicles of the vehicle platoon 1. Such a communication unit 6 may comprise any suitable components for establish communication between the vehicles. For example, the communication unit 6 may comprise a transmitter and a receiver based on radio waves or microwaves. In other words, each vehicle can be part of a local network for communication 7 between the vehicles of the vehicle platoon 1. By means of the local network, control signals can be transmitted from one vehicle to another vehicle. The control signals received are then used by the control unit 5 arranged on the vehicle for controlling the driving behaviour of the vehicle. Such control signals received by the following vehicles 3 are preferably at least initially provided by the lead vehicle 2.

Such a vehicle platoon 1 of a transportation system is suitably part of a central network for communication 9 between the vehicle platoon 1 and a central control unit 10. By means of the central network, control signals can be transmitted from the central control unit 10 to the vehicle platoon 1 for controlling the driving behaviour of the vehicle platoon. Such control signals are preferably received by the lead vehicle 2 of the vehicle platoon, but could also be received by one or more of the following vehicles 3 of the vehicle platoon. The central control unit 10 can be part of a server of a wireless network, such as Internet, for cloud computing.

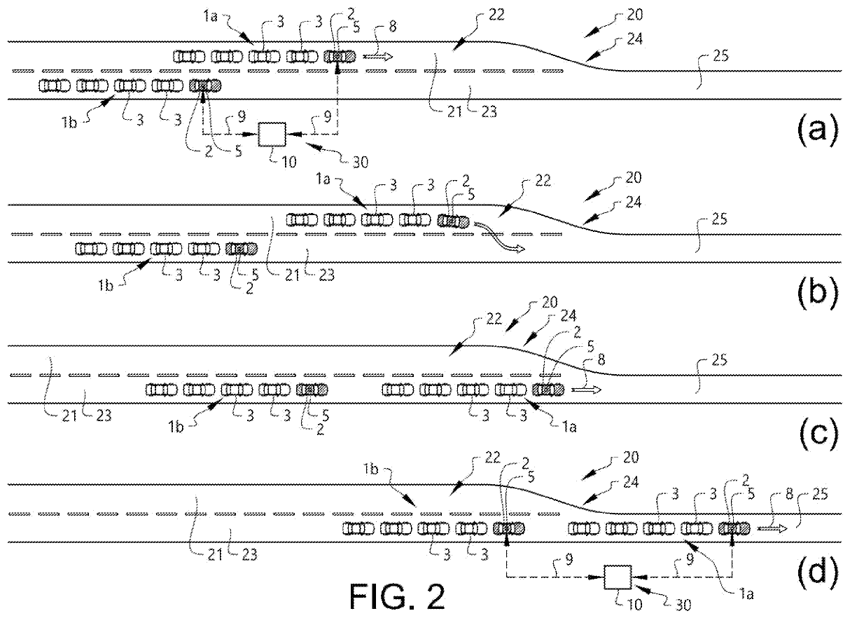

FIG. 2 shows a transportation system 20 which comprises a first vehicle platoon 1a and a second vehicle platoon 1b. Each vehicle platoon 1a, 1b has a lead vehicle 2 and a plurality of vehicles 3 following the lead vehicle 2 as described hereinabove. The transportation system 20 further comprises a control system 30 configured to control the first vehicle platoon 1a and the second vehicle platoon 1b. In the example embodiment shown in FIG. 2, the control system comprises a central control unit 10. Further, the road 22 has a first lane 21 and a second lane 23 arranged side by side to enable driving in one and the same direction 8 (from left to right in FIG. 2). The road 22 has a bottleneck section 24 where the first lane 21 and the second lane 23 merge into a single lane 25 of the road 22.

It should be stressed that the operation of the transportation system 20 described herein is preferably performed by controlling the vehicle platoons 1a, 1b by means of the equipment and control units described herein, without any assistance from any driver of any of the vehicles.

A method for operating a transportation system comprising a first vehicle platoon and a second vehicle platoon, will be described with reference to FIG. 2. FIG. 2 comprises four pictures a), b), c) and d), illustrating the first and second vehicle platoons at different points in time.

The method comprises the steps of controlling the first vehicle platoon 1a and the second vehicle platoon 1b by means of the control system 30, initially driving the first vehicle platoon 1a in the first lane 21 of the road 22 and the second vehicle platoon 1b in the second lane 23 of the road 22, and controlling the first vehicle platoon 1a and the second vehicle platoon 1b such that the first vehicle platoon and the second vehicle platoon are synchronized before reaching the bottleneck section 24 enabling the first vehicle platoon 1a and the second vehicle platoon 1b to enter the single lane 25 one after the other.

The synchronization may comprise positioning of the first vehicle platoon 1a in front of the second vehicle platoon 1b before the bottleneck section 24 enabling the first vehicle platoon 1a to enter the single lane 25 before the second vehicle platoon 1b. In the example embodiment illustrated in FIG. 2, the speed of the first vehicle platoon 1a is increased relative to the speed of the second vehicle platoon 1b before the bottleneck section 24. This can be performed by increasing the speed of the first vehicle platoon and/or decreasing the speed of the second vehicle platoon. See pictures a) and b) of FIG. 2 where the first vehicle platoon 1a passes the second vehicle platoon 1b.

Thereafter, the first vehicle platoon 1a can be controlled to change from the first lane 21 to the second lane 23 of the road 22, to a position in front of the second vehicle platoon 1b, and the first vehicle platoon 1a is then driven in front of the second vehicle platoon 1b in the second lane 23 when reaching the bottleneck section 24 as illustrated in pictures c) and d) of FIG. 2. Although not illustrated, alternatively, the second vehicle platoon could be controlled to change from the second lane to the first lane of the road, to a position behind the first vehicle platoon, where the second vehicle platoon is then driven behind the first vehicle platoon in the first lane when reaching the bottleneck section 24.

The relative speed between the first vehicle platoon 1a and the second vehicle platoon 1b, and the positions of the first vehicle platoon 1a and the second vehicle platoon 1b relative to each other, are preferably controlled based on the length of the first vehicle platoon 1a, before reaching the bottleneck section 24, so as to optimize the throughput at the same time as safety can be ensured.

Furthermore, of course, in another embodiment, the first vehicle platoon and the second vehicle platoon can be synchronized such that the second vehicle platoon will enter the single lane 25 before the first vehicle platoon.

With further reference to FIG. 2, the invention also relates to a control system 30 for controlling vehicles of a transportation system 20 comprising a first vehicle platoon 1a and a second vehicle platoon 1b, where each of the first and second vehicle platoons has a lead vehicle 2 and a plurality of vehicles 3 following the lead vehicle. The control system is configured to control the first vehicle platoon 1a driving in a first lane 21 of a road 22 and the second vehicle platoon 1b driving in a second lane 23 of the road 22, and to control the first vehicle platoon 1a and the second vehicle platoon 1b such that the first vehicle platoon and the second vehicle platoon are synchronized before reaching the bottleneck section 24 enabling the first vehicle platoon 1a and the second vehicle 1b platoon to enter the single lane 25 one after the other.

The control system can suitably comprise one or more central control units 10 and/or one or more of the local control units 5, which units can be used individually and in cooperation.

In the example embodiment illustrated in FIG. 2, the control system 30 comprises a central control unit 10. The central control unit 10 is configured and arranged to communicate 9 with the vehicle platoons 1a, 1b, preferably with the control unit 5 of the lead vehicle 2 of each vehicle platoon 1a, 1b, for controlling the driving of the vehicle platoons 1a, 1b.

The central control unit 10 and the local control unit 5 arranged on a vehicle 2, 3 may comprise one or more microprocessors and/or one or more memory devices or any other components for mutual communication, and for communicating with other equipment. By means of the control units, the vehicle platoons can be controlled, and particularly computer programs to perform the method described herein can be executed. Thus, the central control unit and/or the local control unit is preferably provided with a computer program comprising program code means for performing the steps of any example embodiment of the method described herein.

Optionally, the control system may comprise a decentralized network of computers not necessarily arranged in one and the same central control unit.

Alternatively or in addition to what has been described hereinabove, sensors can be arranged in the environment to the current road where the vehicle platoons are driven. These sensors may provide information received by the control system. Such sensors could be a complement to the sensors of the vehicles for instance, giving further information and/or redundancy to the system.

It is to be understood that the present invention is not limited to the embodiments described above and illustrated in the drawings; rather, the skilled person will recognize that many changes and modifications may be made within the scope of the appended claims.

What is claimed is:

1. A method for operating a transportation system comprising a first vehicle platoon and a second vehicle platoon, each of the first and second vehicle platoons having a lead vehicle and a plurality of vehicles following the lead vehicle, the method comprising the steps of controlling the first vehicle platoon and the second vehicle platoon by means of a control system, driving the first vehicle platoon in a first lane of a road and the second vehicle platoon in a second lane of the road, the road comprising a bottleneck section where the first lane and the second lane merge into a single lane, and controlling the first vehicle platoon and the second vehicle platoon such that the first vehicle platoon and the second vehicle platoon are synchronized before reaching the bottleneck section enabling the first vehicle platoon and the second vehicle platoon to enter the single lane one after the other, and positioning the first vehicle platoon in front of the second vehicle platoon before the bottleneck section, enabling the first vehicle platoon to enter the single lane before the second vehicle platoon.

2. The method according to claim 1, wherein positioning the first vehicle platoon in front of the second vehicle platoon by increasing the speed of the first vehicle platoon relative to the speed of the second vehicle platoon before the bottleneck section by increasing the speed of the first vehicle platoon and/or decreasing the speed of the second vehicle platoon.

3. The method according to claim 1, wherein controlling the first vehicle platoon to change from the first lane to the second lane of the road, and driving the first vehicle platoon in front of the second vehicle platoon in the second lane when reaching the bottleneck section.

4. The method according to claim 1, wherein controlling the second vehicle platoon to change from the second lane to the first lane of the road, and driving the second vehicle platoon behind the first vehicle platoon in the first lane when reaching the bottleneck section.

5. The method according to claim 1, wherein controlling the relative speed between the first vehicle platoon and the second vehicle platoon, and the positions of the first vehicle platoon and the second vehicle platoon relative to each other, based on the length of the first vehicle platoon, before reaching the bottleneck section.

6. A control system for controlling vehicles of a transportation system comprising a first vehicle platoon and a second vehicle platoon, each of the first and second vehicle platoons having a lead vehicle and a plurality of vehicles following the lead vehicle, the control system being configured to control the first vehicle platoon driving in a first lane of a road and the second vehicle platoon driving in a second lane of the road, the road comprising a bottleneck section where the first lane and the second lane merge into a single lane, and the control system being configured to control the first vehicle platoon and the second vehicle platoon such that the first vehicle platoon and the second vehicle platoon are synchronized before reaching the bottleneck section enabling the first vehicle platoon and the second vehicle platoon to enter the single lane one after the other, and the control system being configured to position the first vehicle platoon in front of the second vehicle platoon before the bottleneck section, enabling the first vehicle platoon to enter the single lane before the second vehicle platoon.

7. The control system according to claim 6, wherein the control system is configured to position the first vehicle platoon in front of the second vehicle platoon by increasing the speed of the first vehicle platoon relative to the speed of the second vehicle platoon before the bottleneck section by increasing the speed of the first vehicle platoon and/or decreasing the speed of the second vehicle platoon.

8. The control system according to claim 6, wherein the control system is configured to control the first vehicle platoon to change from the first lane to the second lane of the road, and to drive the first vehicle platoon in front of the second vehicle platoon in the second lane when reaching the bottleneck section.

9. The control system according to claim 6, wherein the control system is configured to control the second vehicle platoon to change from the second lane to the first lane of the road, and to drive the second vehicle platoon behind the first vehicle platoon in the first lane when reaching the bottleneck section.

10. The control system according to claim 6, wherein the control system is configured to control the relative speed between the first vehicle platoon and the second vehicle platoon, and the positions of the first vehicle platoon and the second vehicle platoon relative to each other, based on the length of the first vehicle platoon, before reaching the bottleneck section.

11. A non-transitory computer readable medium storing a computer program comprising program code that, when executed, performs the method of claim 1.

12. A transportation system comprising a first vehicle platoon and a second vehicle platoon, each of the first and second vehicle platoons having a lead vehicle and a plurality of vehicles following the lead vehicle, and a control system configured to control the first vehicle platoon driving in a first lane of a road and the second vehicle platoon driving in a second lane of the road, the road comprising a bottleneck section where the first lane and the second lane merge into a single lane, and the control system being configured to control the first vehicle platoon and the second vehicle platoon such that the first vehicle platoon and the second vehicle platoon are synchronized before reaching the bottleneck section enabling the first vehicle platoon and the second vehicle platoon to enter the single lane one after the other.

13. The transportation system according to claim 12, wherein the control system is configured to position the first vehicle platoon in front of the second vehicle platoon before the bottleneck section enabling the first vehicle platoon to enter the single lane before the second vehicle platoon, and to control the relative speed between the first vehicle platoon and the second vehicle platoon, and the positions of the first vehicle platoon and the second vehicle platoon relative to each other, based on the length of the first vehicle platoon, before reaching the bottleneck section.
